(19) United States
(12) Patent Application Publication
(10) Pub. No.: US 2025/0217737 A1
(43) Pub. Date: Jul. 3, 2025

(54) CHARGE RESERVATION CONTROL APPARATUS, CHARGE RESERVATION CONTROL METHOD, AND PROGRAM

(71) Applicant: NIPPON TELEGRAPH AND TELEPHONE CORPORATION, Tokyo (JP)

(72) Inventors: Hiroki NAGAYAMA, Tokyo (JP); Yukio NAGAFUCHI, Tokyo (JP); Asami MIYAJIMA, Tokyo (JP)

(21) Appl. No.: 18/852,112

(22) PCT Filed: Mar. 31, 2022
(86) PCT No.: PCT/JP2022/016779

§ 371 Date: Sep. 27, 2024

(51) Int. Cl. G06Q 10/0631; G06Q 10/02; G06Q 50/06

(52) U.S. Cl. CPC G06Q 10/06315; G06Q 10/02; G06Q 50/06

(57) ABSTRACT

A charging reservation control device includes: a reception part which receives charging reservation information for a plurality of electric transportation devices and a first prediction value that is a prediction value of suppliable power in a power source; a required power prediction part which calculates a second prediction value that is a prediction value of electric power required for charging the plurality of electric transportation devices on the basis of the charging reservation information; a determination part which determines whether to implement control on the basis of the first prediction value and the second prediction value; and a control part which implements, when the determination part determines that the control is performed, the control so that a concentration of power demand relating to charging of the electric transportation device is reduced.

### TECHNICAL FIELD

The present invention relates to a technique for smoothing power consumption relating to charging of an electric vehicle (hereinafter referred to as an EV).

### BACKGROUND ART

In recent years, EVs have become popular. EVs can be driven by being charged at ordinary households including an EV charger or at a charging facility (also referred to as an EV charging stand, EV station, and the like). As EVs become more widespread, it is expected that many EVs using the same power source will be charging at the same time. At that time, the power supply may not be able to keep up with the rapid increase in power demand, resulting in a power shortage and, in the worst case scenario, a power outage.

### CITATION LIST

### Patent Literature

PTL 1: Japanese Patent Application Publication No. 2007-129873

### SUMMARY OF INVENTION

### Technical Problem

There is a technique in the related art which controls the temperature of air conditioning and the like to smooth the power demand (PTL 1). However, the technique in the related art does not take into consideration the charging demand of EVs and cannot solve the problem of concentration of charging demand of EVs.

The present invention was made in view of the above points, and an object of the present invention is to provide a technique for smoothing power demand using EVs.

### Solution to Problem

According to the disclosed technique, a charging reservation control device including: a reception part which receives charging reservation information for a plurality of electric transportation devices and a first prediction value that is a prediction value of suppliable power in a power source;
a required power prediction part which calculates a second prediction value that is a prediction value of electric power required for charging the plurality of electric transportation devices on the basis of the charging reservation information;
a determination part which determines whether to implement control on the basis of the first prediction value and the second prediction value; and
a control part which implements, when the determination part determines that the control is performed, the control so that a concentration of power demand relating to charging of the electric transportation device is reduced is provided.

### Advantageous Effects of Invention

According to the disclosed technique, it is possible to smooth out power demand due to EVs.

### BRIEF DESCRIPTION OF DRAWINGS

FIG. 1 is a configuration diagram of a system.

FIG. 2 is a hardware configuration diagram of a device.

FIG. 3 is a flowchart for describing an operation of the device.

### DESCRIPTION OF EMBODIMENTS

An embodiment of the present invention (an embodiment) will be described below with reference to the drawings. Embodiments which will be described below are merely examples and embodiments to which the present invention is applied are not limited to the following embodiments.

The scope of application of the technique according to the present invention is not limited to electric vehicles, but includes all types of electric transportation equipment such as motorcycles, tractors, ships, and the like.

### System Configuration

In the embodiment, a concentration of power demand relating to EV charging is avoided by controlling EV charging reservations.

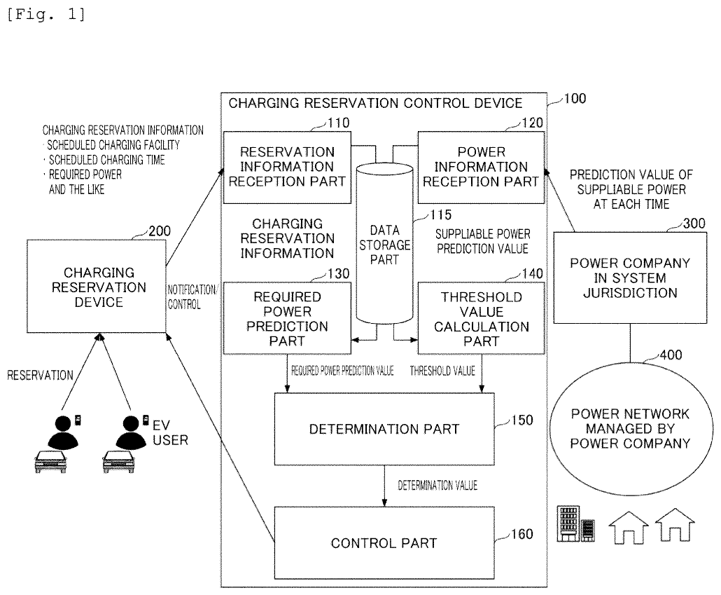

FIG. 1 shows an overall configuration diagram of a system in the embodiment. As shown in FIG. 1, the system includes a charging reservation control device 100 (which may also be referred to as a charging reservation control system), a charging reservation device 200, an electric power company 300 in the system jurisdiction, and a power network 400 managed by the electric power company 300.

The charging reservation control device 100 is a device which controls charging reservations and the details thereof will be described later. The charging reservation device 200 is a device which provides a service of a charging reservation application (hereinafter referred to as a charging reservation application).

In the embodiment, the electric power company 300 supplies electric power to all consumers connected to a power network 400 (power supply network). There are various types of consumers such as ordinary households, public facilities, and companies. The electric power company 300 is an electric power company which has jurisdiction over a certain area. The charging reservation control device 100 also has jurisdiction over this area and this area may be referred to as a system jurisdiction area.

The power network 400 is also connected to EV charging facilities provided by companies, local governments, or the like, general households with EV chargers, and the like as consumers in the system jurisdiction area. In the following description, facilities which can charge EVs including general households which have EV chargers will be referred to as charging facilities.

The power source of the electric power supplied by the electric power company 300 is a power plant such as a thermal power plant, a hydroelectric power plant, or a solar power plant. In power generation using natural energy such as solar power plants, the amount of power which can be supplied changes depending on the weather and other factors.

The charging reservation device 200 provides a charging reservation service to a plurality of charging facilities connected to the power network 400. For example, the charging reservation device 200 displays a reservation screen (web page) on a user terminal (smartphone or the like) including a browser and receives a reservation.

For example, from the reservation screen, a user inputs the charging facility in which he or she wants to charge the EV, the scheduled time to start charging, the required charging time, the required power, and the like. The charging reservation device 200 makes a reservation for a charging facility on the basis of these pieces of input information. An example of the reservation operation will be explained later.

For example, it is assumed that a charging facility (referred to as Charging facility A) can charge up to five devices at the same time. It is assumed that the charging reservation device 200 is in a state of accepting reservations for charging Facility A by five users, Users 1 to 5, for charging at a certain time (Time 1 to Time 2). At this time, even if User 6 requests to reserve the charging Facility A for the relevant time, the reservation will not be received. In this way, the charging reservation device 200 can assign charging time to each of the charging facilities.

### Configuration of Charging Reservation Control Device 100

A configuration of the charging reservation control device 100 will be explained below. As shown in FIG. 1, the charging reservation control device 100 includes a reservation information reception part 110, a data storage part 115, a power information reception part 120, a required power prediction part 130, a threshold value calculation part 140, a determination part 150, and a control part 160. An operation of each of the parts will be described later. Note that the reservation information reception part 110 and the power information reception part 120 may be collectively referred to as a “reception part”.

The charging reservation control device 100 is, for example, a device realized by causing a computer to execute a program. That is to say, the charging reservation control device 100 can be realized by executing a program corresponding to the processing performed by charging reservation control device 100 using hardware resources such as the CPU and the memory built into the computer. The above program can be recorded on a computer-readable recording medium (such as a portable memory) and can be stored or distributed. Furthermore, it is also possible to provide the above program through a network such as the Internet or an e-mail.

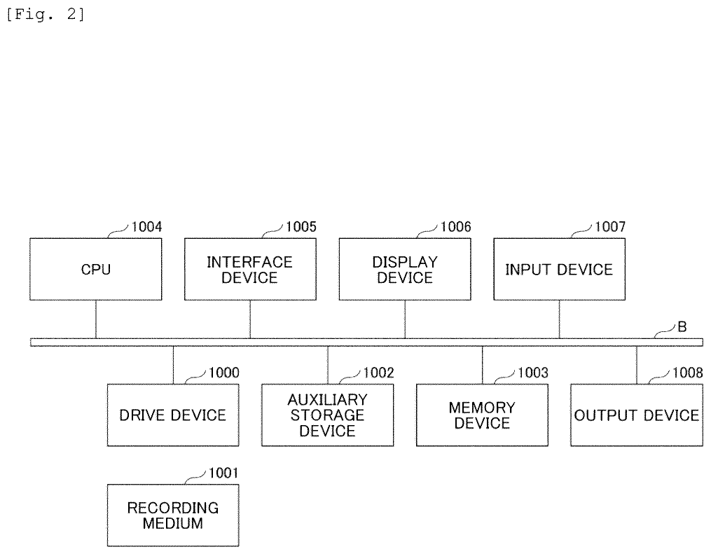

FIG. 2 is a diagram showing an example of a hardware configuration of the computer. The computer in FIG. 2 includes a drive device 1000, an auxiliary storage device 1002, a memory device 1003, a CPU 1004, an interface device 1005, a display device 1006, an input device 1007, an output device 1008, and the like which are connected to each other using a bus BS.

A program for realizing processing using the computer is provided using, for example, a recording medium 1001 such as a CD-ROM or a memory card. When the recording medium 1001 having the program stored therein is set in the drive device 1000, the program is installed from the recording medium 1001 to the auxiliary storage device 1002 via the drive device 1000. Here, the program does not necessarily have to be installed from the recording medium 1001, but may be downloaded from another computer via a network. The auxiliary storage device 1002 stores installed programs as well as necessary files, data, and the like.

The memory device 1003 reads the program from the auxiliary storage device 1002 and stores it when there is an instruction to start the program. The CPU 1004 implements functions relating to the charging reservation control device 100 in accordance with programs stored in the memory device 1003. The interface device 1005 is used as an interface for connecting to a network or the like. The display device 1006 displays a graphical user interface (GUI) or the like based on a program. The input device 1007 is composed of a keyboard, a mouse, buttons, a touch panel, and the like and is used for receiving, as inputs, input various operation instructions. The output device 1008 outputs the calculation result.

Note that the charging reservation control device 100 may be realized using one computer or may be realized using a plurality of computers. Furthermore, the charging reservation control device 100 may be realized using a physical machine or a virtual machine on the cloud.

### Example of Operation of Charging Reservation Control Device 100

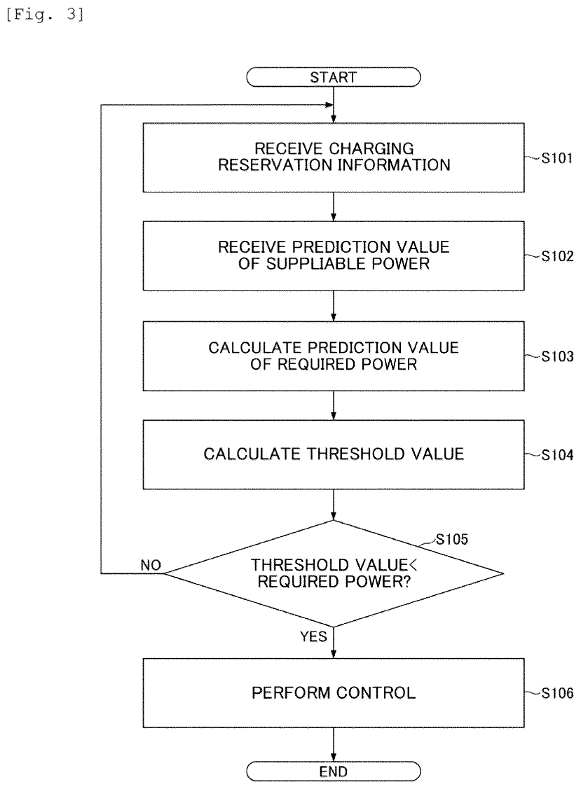

An example of an operation of the charging reservation control device 100 will be described below in accordance with the procedure of the flowchart shown in FIG. 3. FIG. 3 shows the flow until a certain control is performed.

### <S101>

In S101, the reservation information reception part 110 receives charging reservation information from charging reservation device 200. This receiving operation may be performed each time a user makes a charging reservation or may be performed at certain time intervals (for example, every 10 minutes or the like).

When charging reservation information is received at a certain time interval, the reservation information reception part 110 collectively receives the charging reservation information accumulated in charging reservation device 200 during that time interval.

The individual charging reservation information includes, for example, user information of the transmission source, identification information of the scheduled charging facility, scheduled charging start time, required charging time, required power, and the like. The reservation information reception part 110 stores the received charging reservation information in the data storage part 115. An e-mail address or the like for transmitting information to the user terminal may be included as user information of a transmission source.

### <S102>

In S102, the power information reception part 120 receives the prediction value of the suppliable power in the power source at each time from the power company 300. The power information reception part 120 stores the received prediction value in the data storage part 115. The prediction value of the suppliable power received from the power company 300 includes, for example, a prediction value of the suppliable power within a certain time range in the future with respect to the current time. Furthermore, the prediction value of the suppliable power is, for example, a prediction value at a certain time interval.

The “suppliable power” is a maximum power which can be supplied using the power source. Furthermore, the “suppliable power” may be the surplus power obtained by subtracting the predicted total demand from the maximum suppliable power. In the following description, the “suppliable power” will be explained as being the maximum power which can be supplied using the power source.

### <S103>

In S103, the required power prediction part 130 reads the charging reservation information from the data storage part 115 and calculates a prediction value of the required power for charging at each time from the charging reservation information.

The required power prediction part 130 calculates, for example, a prediction value of the required power within a certain time range in the future with respect to the current time. For example, it is assumed that the current time is T, and a prediction value of required power within the range of T+ΔT1 to T+ΔT2 is calculated. Within the range of T+ΔT1 to T+ΔT2, a prediction value for a certain time interval (for example, every 30 minutes, every hour) is calculated.

As an example, if the current time is 0 o'clock, ΔT1=1, ΔT2=3, and the prediction time interval is 1 hour, the required power prediction part 130 predicts the required power at 1 o'clock, 2 o'clock, and 3 o'clock.

The required power at a certain time t can be calculated using the sum of the required power in all charging reservation information whose charging time (time from the start of charging to the end of charging) includes time t.

### <S104>

In S104, the threshold value calculation part 140 calculates a threshold value TH for each time point for determining whether to perform control from the suppliable power prediction value for each time point read from the data storage part 115.

For example, it is assumed that the suppliable power prediction value at a certain time t is SP and it is assumed that the overall power demand prediction value at time t in the jurisdiction of the electric power company 300 is DP. The overall power demand prediction value at time t may be calculated, for example, from past demand performance data by regression analysis or the like or may be received from the power company 300 together with the suppliable power prediction value.

At this time, the threshold value calculation part 140 calculates TH, for example, by setting TH=α(SP−DP). α is a predetermined coefficient and satisfies 1>α>0. That is to say, SP−DP calculates the surplus power which can be supplied and the threshold value is determined by multiplying the surplus power by a coefficient.

Note that, when the suppliable power prediction value received from the electric power company 300 is the above-described surplus power, the threshold value calculation part 140 calculates TH by “TH=α×suppliable power prediction value”.

### <S105>

In S105, the determination part 150 determines whether the required power prediction value for EV charging exceeds a threshold value at each time within the time range in which the required power prediction was performed. When there is a time at which the required power prediction value exceeds a threshold value, the process proceeds to S106, and when there is no time at which the required power prediction value exceeds the threshold value, the process returns to S101.

### <S106>

In S106, the control part 160 extracts charging reservation information having a charging time (time from the start of charging to the end of charging) including the time at which the required power prediction value exceeds the threshold value from the data storage part 115 and controls the user who sent the extracted charging reservation information (the user who made the charging reservation). Examples of control methods include the following methods (1) to (3).
(1) A user who has made charging reservations is prompted to change a charging time or a charging facility.
(2) Options for changing the charging time or the charging facility are presented to a user who has made a charging reservation and the charging reservation is changed on the basis of the selection.
(3) The charging time or the charging facility for a user who has made charging reservations is automatically changed and a notification of the changing is provided.

With regard to the notification to the user in (1) to (3), the control part 160 notifies the charging reservation device 200 of the above content and the charging reservation device 200 provides the notification to the user terminal. Alternatively, the control part 160 may directly provide the notification to the user terminal using an e-mail or the like.

With regard to changing the charging time in (1) to (3), the control part 160 may calculate a charging time at which the required power prediction value is smaller than the threshold value by a certain width and the time difference between before and after the change is as small as possible and set this as the charging time after the change.

With regard to changing the charging facilities in (1) to (3), the control part 160 may present the charging facility closest to the user's location (for example, home, current location using GPS location information, or the like) among the charging facilities outside the jurisdiction of the electric power company 300.

### Other Examples

Although the power source is a power plant of a power company in the above examples, this is merely an example. The power source may be a charger at a specific charging facility. In this case, the required power prediction value is a prediction value at the specific charging facility and the suppliable power prediction value is a prediction value of suppliable power of the charger at the specific charging facility. The determination of whether to perform control and the control details are the same as in the above example.

### Effects of Embodiment

The technique according to the embodiment described above makes it possible to smooth the power demand caused by EVs and prevent sudden power consumption.

### SUPPLEMENT NOTES

With regard to the above embodiments, the following supplement notes are further disclosed.

### Supplement Item 1

A charging reservation control device, comprising:
a memory; and
at least one processor connected to the memory, wherein the processor
receives charging reservation information for a plurality of electric transportation devices and a first prediction value that is a prediction value of suppliable power in the power source,
calculates a second prediction value that is a prediction value of power required for charging the plurality of electric transportation devices on the basis of the charging reservation information,
determines whether to implement control on the basis of the first predicted value and the second predicted value, and
performs control so that a concentration of power demand relating to charging of the electric transportation devices is reduced when it is determined that the control is implemented.

### Supplement Item 2

The charging reservation control device according to Supplement Item 1, wherein the processor
calculates a surplus prediction value of a suppliable power of the power source on the basis of the first prediction value and power demand prediction, calculates a threshold value by multiplying the surplus prediction value by a coefficient, and
determines whether the second prediction value exceeds the threshold value at a certain time in the future.

### Supplement Item 3

The charging reservation control device according to Supplement Item 1 or 2, wherein the power source is a power plant for supplying power to all consumers connected to a power network managed by a power company, and
the charging reservation information is reservation information for charging at a charging facility connected to the power network.

### Supplement Item 4

The charging reservation control device according to Supplement Item 1 or 2, wherein the power source is a charger at a specific charging facility and
the charging reservation information is reservation information for charging at the specific charging facility.

### Supplement Item 5

The charging reservation control device according to any one of Supplement Items 1 to 4, wherein the processor prompts the user who has made the charging reservation to change the charging time or the charging facility or changes the charging time or the charging facility relating to the charging reservation and notifies the user who made the charging reservation of the change.

### Supplement Item 6

A charging reservation control method performed by a computer, comprising:
receiving charging reservation information for a plurality of electric transportation devices and a first prediction value that is a prediction value of suppliable power in a power source;
calculating a second prediction value that is a prediction value of power required for charging the plurality of electric transportation devices on the basis of the charging reservation information;
determining whether to implement control on the basis of the first prediction value and the second prediction value; and
implementing, when it is determined that control is implemented, the control so that a concentration of power demand relating to charging of the electric transportation device is reduced.

### Supplement Item 7

A non-temporary storage medium which stores a program executable using a computer to perform a charging reservation control process, wherein
the charging reservation control process receives charging reservation information for a plurality of electric transportation devices and a first prediction value that is a prediction value of suppliable power in a power source;
calculates a second prediction value that is a prediction value of power required for charging the plurality of electric transportation devices on the basis of the charging reservation information;
determines whether to implement control on the basis of the first prediction value and the second prediction value; and
implements control so that a concentration of power demand relating to charging of the electric transportation device is reduced when it is determined that the control is implemented.

Although the embodiment has been described above, the present invention is not limited to such specific embodiments and various modifications and changes can be made within the scope of the gist of the present invention as described in the claims.

### REFERENCE SIGNS LIST

100 Charging reservation control device
110 Reservation information reception part
115 Data storage part
120 Power information reception part
130 Required power prediction part
140 Threshold value calculation part
150 Determination part
160 Control part
200 Charging reservation device
300 Power company
400 Power network
1000 Drive device
1001 Recording medium
1002 Auxiliary storage device
1003 Memory device
1004 CPU
1005 Interface device
1006 Display device
1007 Input device
1008 Output device

1. A charging reservation control device, comprising:
a memory; and
a processor coupled to the memory and configured to:
receive charging reservation information for a plurality of electric transportation devices and a first prediction value that is a prediction value of suppliable power in a power source;
calculate a second prediction value that is a prediction value of electric power required for charging the plurality of electric transportation devices on the basis of the charging reservation information;
determine whether to implement control on the basis of the first prediction value and the second prediction value; and
implement, when the processor determines that the control is performed, the control so that a concentration of power demand relating to charging of the electric transportation device is reduced.

2. The charging reservation control device according to claim 1, wherein the processor is further configured to:
calculate a surplus prediction power of the suppliable power in the power source on the basis of the first prediction value and the power demand prediction and calculate a threshold value by multiplying the surplus prediction value by a coefficient, and
wherein the processor determines whether the second prediction value exceeds the threshold value at a certain time in the future.

3. The charging reservation control device according to claim 1, wherein
the power source is a power plant which supplies power to all consumers connected to a power network managed by the power company, and
the charging reservation information is reservation information for charging at a charging facility connected to the power network.

4. The charging reservation control device according to claim 1, wherein
the power source is a charger at a specific charging facility, and
the charging reservation information is reservation information for charging at the specific charging facility.

5. The charging reservation control device according to claim 1, wherein the processor prompts a user who has made a charging reservation to change a charging time or a charging facility or changes the charging time or the charging facility relating to the charging reservation and notifies the user who made the charging reservation of the change.

6. A charging reservation control method performed by a computer, comprising:
receiving charging reservation information for a plurality of electric transportation devices and a first prediction value that is a prediction value of suppliable power in a power source;
calculating a second prediction value that is a prediction value of power required for charging the plurality of electric transportation devices on the basis of the charging reservation information;
determining whether to implement control on the basis of the first prediction value and the second prediction value; and
implementing, when it is determined that the control is performed, the control so that a concentration of power demand relating to charging of the electric transportation device is reduced.

7. A non-transitory computer-readable recording medium storing a program causing a computer to perform the method of claim 6.
